(19) United States
(12) Patent Application Publication
(10) Pub. No.: US 2015/0189126 A1
(43) Pub. Date: Jul. 2, 2015

(54) CONTROLLING CONTENT FRAME RATE BASED ON REFRESH RATE OF A DISPLAY

(71) Applicant: Nvidia Corporation, Santa Clara, CA (US)

(72) Inventors: Tao Xie, Santa Clara, CA (US); Matthew Wagner, San Francisco, CA (US); Ilan Aelion, Fort Collins, CO (US)

(73) Assignee: Nvidia Corporation, Santa Clara, CA (US)

(21) Appl. No.: 14/146,679

(22) Filed: Jan. 2, 2014

(51) Int. Cl. H04N 5/04; G09G 5/18

(52) U.S. Cl. CPC H04N 5/04; G09G 5/18

(57) ABSTRACT

A video frame producer, a method of generating content frames and a video viewing device are disclosed herein. In one embodiment, the video frame producer includes: (1) a content provider configured to generate content frames for a display and (2) a viewing smoother configured to direct the content provider to generate the content frames at a frame rate based on a display refresh rate of the display.

### TECHNICAL FIELD

This application is directed, in general, to computer generated video and, more specifically, to improving a user's perception of computer generated video.

### BACKGROUND

Video gaming is a rapidly growing commercial field that is receiving a great deal of attention due to its universal interest and appeal. Video games can provide an immersive experience for users by generating life-like video that corresponds to input from a user or users. Typically, graphic processing units are employed to generate the video images by rendering individual frames that are provided to the display of a gaming device, including a personal computer, a smart phone or other mobile computing device.

The source of the video game content to be displayed is often a video game program that is loaded or stored on the viewing device. In addition to video game content, a proliferation of conventional, or “mainstream” content, as well as non-conventional, amateur or home-made content is also being created for display. As in a server-client remote graphics processing arrangement, the conventional and non-conventional content is transmitted over a network to a viewing device or devices.

### SUMMARY

In one aspect, a video frame producer is disclosed. In one embodiment, the video frame producer includes: (1) a content provider configured to generate content frames for a display and (2) a viewing smoother configured to direct the content provider to generate the content frames at a frame rate based on a display refresh rate of the display.

In another aspect, a method of generating content frames for a display is disclosed. In one embodiment, the method includes: (1) receiving video data to be generated as content frames for a display, (2) obtaining a display refresh rate of the display and (3) generating, by a processor, the content frames at a rate based on the display refresh rate.

In yet another aspect, a video viewing device is disclosed. In one embodiment, the video viewing device includes: (1) a processor, (2) a display having a display refresh rate and (3) a video frame producer configured to generate content frames for the display at a rate based on the display refresh rate.

### BRIEF DESCRIPTION

Reference is now made to the following descriptions taken in conjunction with the accompanying drawings, in which:

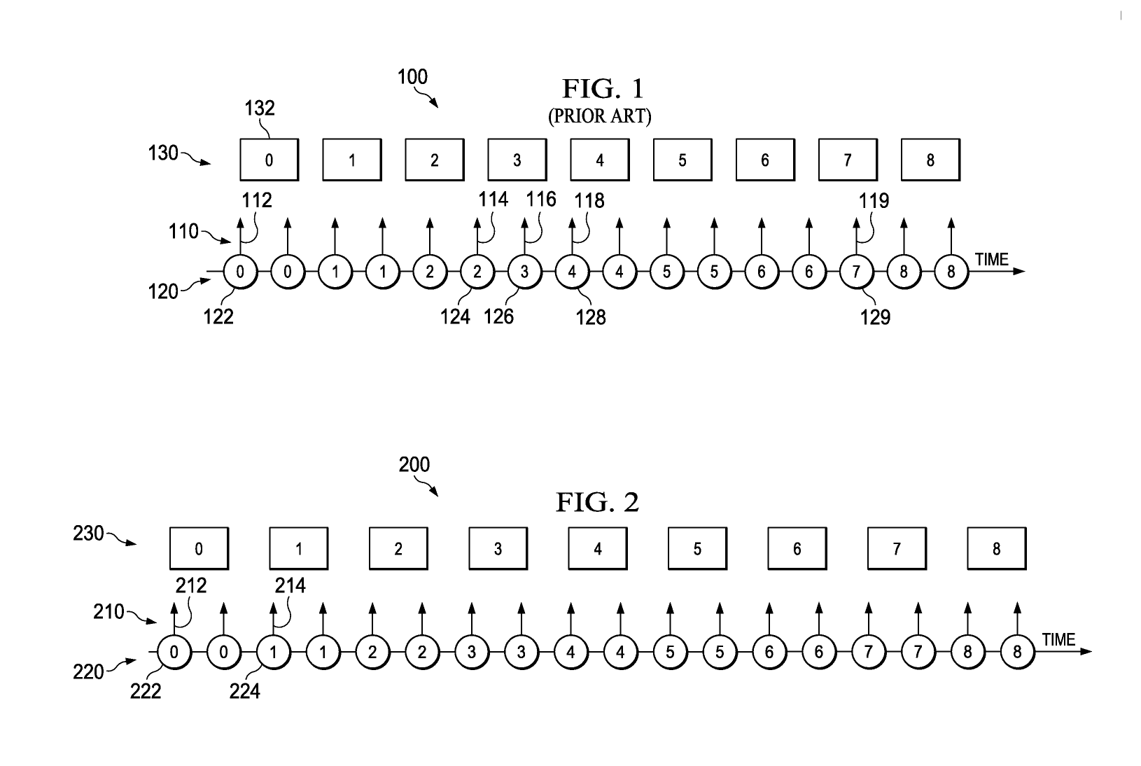

FIG. 1 illustrates a timing diagram showing the display of content frames when the display refresh rate of a display is not considered;

FIG. 2 illustrates a timing diagram showing the display of content frames generated at a frame rate based on the display refresh rate of a display;

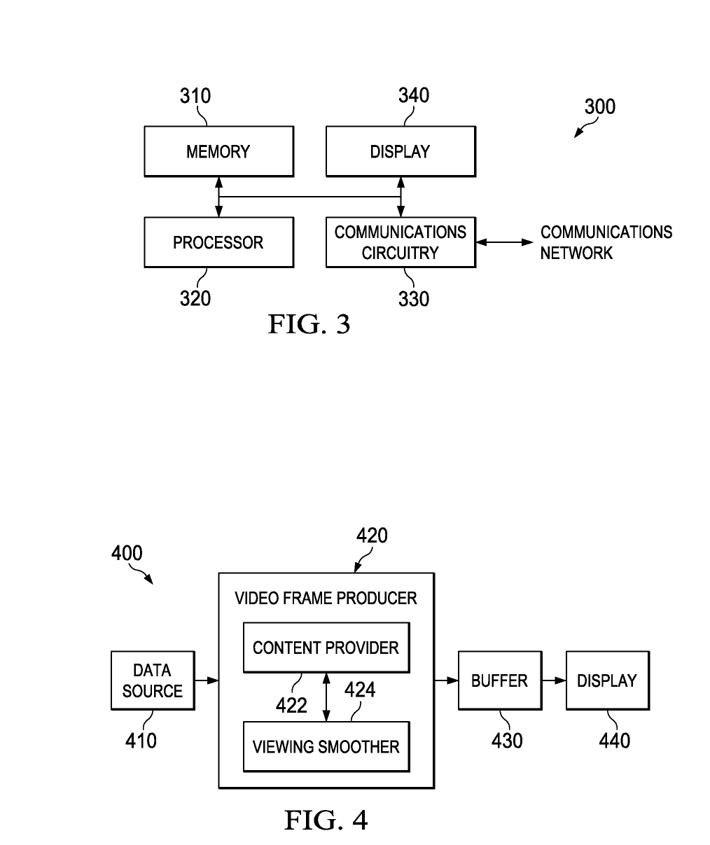

FIG. 3 illustrates a block diagram of a video viewing device constructed according to the principles of the disclosure;

FIG. 4 illustrates a block diagram of another embodiment of a video viewing device constructed according to the principles of the disclosure; and

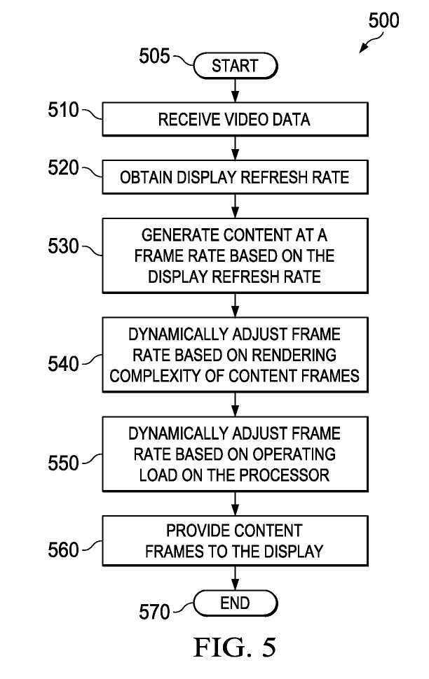

FIG. 5 illustrates a flow diagram of an embodiment of a method of generating content frames carried out according to the principles of the disclosure.

### DETAILED DESCRIPTION

With the development of new graphic processing units, rendering capability or content generation continues to improve. To improve the life-like experience, manufacturers and developers strive for a higher frame rate. The disclosure recognizes that simply pushing for a higher frame rate fails to consider the rhythm of the resulting frame rate against the display of the viewing device. For example, the disclosure realizes that in a 60 Hertz (Hz) display refresh system, existing solutions will favor a higher frame rate of 35 frames per second (fps) than a lower frame rate of 30 fps. With this solution, however, an average of five frames have to be dropped every second from the favored 35 frames. Dropping frames can generate jerkiness from the viewing perspective of a user.

FIG. 1 illustrates a timing diagram showing the display of content frames, such as video data frames, when the display refresh rate of a display is not considered. For ease of explanation, the rendering time for each of the content frames is assumed to be the same in FIG. 1. The x-axis is a time axis with each vertical arrow representing a cycle of a display refresh rate for a display. A display refresh rate denotes how many times a screen of a display is redrawn each second. Typically, the display refresh rate is measured in Hz.

The vertical arrows, i.e., the display refresh rate cycles, are denoted collectively as 110. The circles associated with the display refresh rate cycles 110 include a number that indicates the frame which will be displayed at the particular display refresh rate cycle and are denoted collectively as displayed frames 120. Some of the displayed frames 120 are specifically denoted and referred to in the below discussion.

FIG. 1 also includes generated or rendered content frames, denoted collectively as 130. A content frame is a data frame that is combined with a series of data frames to create a video stream. The left edge of each of the content frames indicates the time when the frame is available for display. Eight different content frames 130 and sixteen display refresh rate cycles 110 are illustrated in FIG. 1. At the first display refresh rate cycle 112, the first content frame, frame 0, is ready for display and is denoted as the displayed frame 122. A content frame is ready for display when rendering of the frame is complete. At display refresh rate cycle 114 frame 2 is ready for display and is denoted as the displayed frame 124. At this point, each of the content frames 0, 1 and 2 have been displayed an equal amount of time. In this example, each of these data frames have been displayed for two of the display refresh rate cycles 110. This changes with frame 3 which is only displayed for a single cycle at display refresh rate cycle 116 as indicated by displayed frame 126. At the subsequent display refresh rate cycle 118, rendering of frame 4 is complete and is already ready for display. As such, frame 4 is the displayed frame 128. Similarly, frame 7 is only displayed for a single display refresh rate cycle at display refresh rate cycle 119 as indicated by the displayed frame 129.

Displaying content frames for different amounts of time, such as an unequal number of display refresh rate cycles, provides an uneven viewing experience for a user. Accordingly, the disclosure provides a mechanism to control content generation rate based on the refresh rate of a display. Thus, in contrast to existing solutions, the disclosure is directed to improving the subjective viewing experience of a user instead of focusing on increasing the content frame rate. As such, in one embodiment a video device is disclosed that displays content frames for an equal number of display refresh rate cycles and avoids or at least substantially reduces dropping, skipping or replication of content frames in the display stage. This will improve the subjective viewing experience of a user.

The disclosure considers the refresh rate of a display and generates the content frames at a rate in-synch with the display refresh rate. For example, in a 60 Hz display system, the disclosure favors generating frames at a content rate of 30 fps over 35 fps or 20 fps over 22 fps. Thus, the disclosure provides a viewing device that generates content frames at a rate that is a positive divisor of the refresh rate of the display wherein the content is provided. The disclosed video viewing device, method and scheme delivers an improved user viewing experience. The disclosure also provides the additional benefit of reduced power consumption since a system having a lower content frame rate consumes less power.

For example, FIG. 2 illustrates a timing diagram 200 showing the display of content frames generated at a frame rate based on the display refresh rate of a display. As in FIG. 1, the rendering time for each of the content frames is assumed to be the same for ease of explanation and the left edge of each of the content frames 230 indicate the time when the frame is available for display. Eight different content frames 230 and sixteen display refresh rate cycles 210 are illustrated in FIG. 2. At the first display refresh rate cycle 212, the first video data frame, frame 0, is ready for display and is denoted as the displayed frame 222. At display refresh rate cycle 214, frame 2 is ready for display and is denoted as the displayed frame 224. Accordingly, frame 0 was displayed for two cycles of the display refresh rate. This is also true for the remaining content frames 1-8 since the frame rate is based on the display refresh rate such that each of the content frames 230 are displayed for the same number of cycles of the display refresh rate. Thus, unlike FIG. 1, each of the content frames 230 are displayed an equal amount of time. As such, even with a lower frame rate than the frame rate of FIG. 1, the subjective viewing experience of a user is improved when the frame rate is based on the display refresh rate.

FIG. 3 illustrates a block diagram of a video viewing device 300 constructed according to the principles of the disclosure. The video viewing device 300 may be a smart phone, a game device or another viewing device that displays generated data frames. The video viewing device 300 includes a memory 310, a processor 320, communications circuitry 330 and a display 340.

The memory 310 is configured to store data and programs that are employed by the video viewing device 300. The memory 310 can be a memory that is typically included in video viewing devices, such as a conventional memory employed therein. In one embodiment, the memory 310 includes an application, such as a video game, that provides video data. The video data includes data for visually presenting the video game to a user based on user input/output, animation, scene graphics, etc.

The processor 320 is configured to direct the operation of the video viewing device 300 and generate content frames based on the video data. The processor 220 includes the necessary logic and/or circuitry to generate the content frames based on the display refresh rate of the display 340. In one embodiment, the determined content frame rate is a positive divisor of the display refresh rate. In some embodiments, the processor 320 is configured to generate content frames at a frame rate less than the maximum or possible frame rate that it is capable of generating. For example, the processor 320 may be capable of generating 35 fps but generates the frames at 30 fps based on a 60 Hz display refresh rate.

In one embodiment, the processor 320 is also configured to dynamically adjust the frame rate based on complexity of the frames. For example, the processor 320 may be generating the frames at 30 fps based on the display refresh rate of 60 Hz. Due to the complexity of some frames, the time needed for rendering is increased such that 30 fps can no longer be obtained. A lower frame rate, such as 28 fps, could be maintained however this would result in unequal display time for the rendered frames. Accordingly, the processor 320 is configured to adjust the frame rate to a rate that is a positive divisor of the display refresh rate. Thus, the processor 320 can be configured to adjust the frame rate based on rendering complexity in addition to the consideration of the display refresh rate.

In some embodiments, the processor 320 is further configured to dynamically adjust the frame rate based on the operating load or available operating capacity on the processor 320. Additional programs or applications can be running on the processor 320 that slows down the rendering capability of the processor 320. The processor 320 is configured to dynamically adjust the content rate when needed to stay in-synch with the display refresh rate of the display 340. Accordingly, the processor 320 is configured to change the content frame rate from one positive divisor of the display refresh rate to another positive divisor of the display refresh rate.

The communications circuitry 330 is conventional communication circuitry that is configured to communicate data over a communications network, such as a conventional communications network. The communications circuitry 330 includes the necessary circuitry and logic to communicate data including, for example, as an antenna. In one embodiment, the video viewing device 300 is a smart phone and the communications circuitry 330 is configured to communicate over a cellular network and/or a wireless local area network. In some embodiments, the video viewing device 300 is configured to receive video data from a communications network via the communications circuitry 330. For example, video data can be generated at a server and transmitted to the viewing device 300 via a video stream.

The display 340 is an electronic device that is configured to represent the video data in visual form. The display 340 can be a conventional display that is typically employed in a video viewing device such as a smart phone. The display 340 continuously updates or refreshes itself at a known display refresh rate. The display refresh rate can vary for different type of displays.

FIG. 4 illustrates a block diagram of an embodiment of a video viewing device 400 constructed according to the principles of the disclosure. The video viewing device 400 is configured to generate content frames from a data source and provide the content frames to a display for viewing. In one embodiment, the video viewing device 400 is a computer pad. In other embodiments, the video viewing device 400 can be a lap top computer, a desk top computer, a smart phone, a game device, etc. The video viewing device 400 includes a data source 410, a video frame producer 420, a buffer 430 and a display 440. One skilled in the art will understand that the video viewing device 400 can include additional components that are typically included with video viewing devices.

The data source 410 is configured to provide video data that is to be displayed. The data source 410 can be a video game that generates the video data. The data source 410 may be a program or application stored on a memory of the video viewing device 400. In some embodiments, the data source 410 can receive at least a portion of the video data via be a remote server.

The video frame producer 420 is configured to generate content frames from the video data. The video frame producer 420 includes a content provider 422 and a viewing smoother 424. The content provider 422 is configured to generate the content frames for the display 440. The content provider 422 may include the functionality of an encoder. Additionally, the content provider 422 is coupled to the viewing smoother 424 and is configured to generate the content frames based on instructions from the viewing smoother 424. The viewing smoother 424 is configured to direct the content provider 422 to generate the content frames at a frame rate based on a display refresh rate of the display 440. The instructions or control information from the viewing smoother 424 directs the content provider 422 to synchronize the frame rate with the display refresh rate of the display 440 employing a frame rate that is a positive divisor of the display refresh rate. In one embodiment, the viewing smoother 424 is configured to determine the display refresh rate via a function call to the display 440. In other embodiments, the viewing smoother 424 is loaded with the display refresh rate during manufacturing.

The viewing smoother 424 is further configured to dynamically adjust the frame rate based on the rendering complexity of the content frames. In some embodiments, the viewing smoother 424 is also configured to dynamically adjust the frame rate based on operation of an additional application on the video viewing device 400. The viewing smoother 424 can dynamically adjust the frame rate up or down as the rendering complexity and operating load change.

The buffer 430 is a memory area located between the video frame producer 420 and the display 440 that provides temporary storage for the content frames being transmitted from the video frame producer 420 to the display 440. The buffer 430 can be a conventional buffer typically employed in video viewing devices. For example, the buffer 430 can be a jitter resolving buffer.

The display 440 is an electronic device that is configured to represent the video data in visual form. The display 440 can be a conventional display that is typically employed in video viewing devices such as a desktop or laptop computer. The display 440 has a display refresh rate that determines how many times the display or screen is redrawn each second.

FIG. 5 illustrates a flow diagram of an embodiment of a method 500 of generating content frames carried out according to the principles of the disclosure. The method 500 or at least a portion thereof is carried out by a processor. In one embodiment, the method 500 is performed by a video frame producer of a video viewing device such as disclosed herein. The method 500 begins in a step 505.

In a step 510, video data is received. The video data is to be generated as content frames for a display. The video data can be received via a local or a remote data source.

A display refresh rate of the display is obtained in a step 520. The display refresh rate may be obtained from the display via, for example, a function call to the display. In some embodiments, the display refresh rate is received during manufacturing of the video viewing device. The display refresh rate can be stored in a memory of the video viewing device. In some embodiments, the display refresh rate is stored in a video smoother.

In a step 530, the content frames are generated at a frame rate based on the display refresh rate. Generating the content frames includes coordinating the frame rate with the display refresh rate to reduce unequal display time of frames. In one embodiment, the content frame rate is a maximum positive divisor of the display refresh rate.

In a step 540, the content frame rate is dynamically adjusted based on rendering complexity of at least some of the content frames. In one embodiment, the rendering complexity is determined in real time by analyzing the time that was needed for rendering, i.e., post event analysis. Based thereon, the frame rate is determined based on the rendering complexity and the display refresh rate such that the frame rate is in synch with display refresh rate.

In a step 550, the method 500 continues by dynamically adjusting the frame rate based on available operating capacity of the processor rendering the content frames. The amount of operating capacity available can be determined via conventional means.

In a step 560, the generated content frames are provided to the display. In one embodiment, the content frames are provided thereto via a buffer. The method 500 ends in a step 570.

While the method disclosed herein has been described and shown with reference to particular steps performed in a particular order, it will be understood that these steps may be combined, subdivided, or reordered to form an equivalent method without departing from the teachings of the present disclosure. Accordingly, unless specifically indicated herein, the order or the grouping of the steps is not a limitation of the present disclosure.

A portion of the above-described apparatuses, systems or methods may be embodied in or performed by various processors, such as conventional digital data processors or computing devices, wherein the processors are programmed or employ stored executable programs of sequences of software instructions to perform one or more of the steps of the methods. The software instructions of such programs may represent algorithms and be encoded in machine-executable form on non-transitory digital data storage media, e.g., magnetic or optical disks, random-access memory (RAM), magnetic hard disks, flash memories, and/or read-only memory (ROM), to enable various types of digital data processors or computing devices to perform one, multiple or all of the steps of one or more of the above-described methods, or functions of the apparatuses described herein.

Portions of disclosed embodiments may relate to computer storage products with a non-transitory computer-readable medium that have program code thereon for performing various computer-implemented operations that embody a part of an apparatus, system or carry out the steps of a method as set forth herein. Non-transitory used herein refers to all computer-readable media except for transitory, propagating signals. Examples of non-transitory computer-readable media include, but are not limited to: magnetic media such as hard disks, floppy disks, and magnetic tape; optical media such as CD-ROM disks; magneto-optical media such as floptical disks; and hardware devices that are specially configured to store and execute program code, such as ROM and RAM devices. Examples of program code include both machine code, such as produced by a compiler, and files containing higher level code that may be executed by the computer using an interpreter.

Those skilled in the art to which this application relates will appreciate that other and further additions, deletions, substitutions and modifications may be made to the described embodiments.

What is claimed is:

1. A video frame producer, comprising:
a content provider configured to generate content frames for a display; and
a viewing smoother configured to direct said content provider to generate said content frames at a frame rate based on a display refresh rate of said display.

2. The video frame producer as recited in claim 1 wherein said viewing smoother is further configured to dynamically adjust said frame rate based on rendering complexity of said content frames.

3. The video frame producer as recited in claim 1 wherein said video frame producer is part of a video viewing device and said viewing smoother is further configured to dynamically adjust said frame rate based on operation of an additional application on said video viewing device.

4. The video frame producer as recited in claim 1 wherein said viewing smoother is configured to coordinate said frame rate with said display refresh rate to generate said frames at a maximum positive divisor of said display refresh rate.

5. The video frame producer as recited in claim 1 wherein said content provider is configured to generate said content frames at a first frame per second rate and said viewing smoother is configured to direct said content provider to generate said content frames at a second frame per second rate less than said first rate.

6. The video frame producer as recited in claim 1 wherein said viewing smoother dynamically adjusts a frame per second rate of said content provider.

7. The video frame producer as recited in claim 1 wherein said frame rate is less than said display refresh rate.

8. A method of generating content frames for a display, comprising:
receiving video data to be generated as content frames for a display;
obtaining a display refresh rate of said display; and
generating, by a processor, said content frames at a rate based on said display refresh rate.

9. The method as recited in claim 8 further comprising dynamically adjusting said frame rate based on rendering complexity of said content frames.

10. The method as recited in claim 8 further comprising dynamically adjusting said frame rate based on available operating capacity of said processor.

11. The method as recited in claim 8 wherein said generating includes coordinating said frame rate with said display refresh rate to display said content frames in synch with said display refresh rate.

12. The method as recited in claim 8 wherein said content frame rate is a positive divisor of said display refresh rate.

13. The method as recited in claim 12 wherein said positive divisor is a maximum positive divisor of said display refresh rate.

14. The method as recited in claim 8 further comprising providing said generated content frames to said display via a buffer.

15. A video viewing device, comprising:
a processor;
a display having a display refresh rate; and
a video frame producer configured to generate content frames for said display at a rate based on said display refresh rate.

16. The video viewing device as recited in claim 1 wherein said video frame producer is configured to dynamically adjust said frame rate based on rendering complexity of said content frames.

17. The video viewing device as recited in claim 1 wherein said video frame producer is configured to dynamically adjust said frame rate based on operating load on said processor.

18. The video viewing device as recited in claim 1 further comprising a memory configured to store an application that provides said video data to said video frame producer.

19. The video viewing device as recited in claim 1 wherein said video viewing device is a smart phone.

20. The video viewing device as recited in claim 1 wherein said video frame producer is configured to generate said content frames at a rate that is a positive divisor of said display refresh rate.
